(19) United States
(12) Patent Application Publication
(10) Pub. No.: US 2011/0289015 A1
(43) Pub. Date: Nov. 24, 2011

(54) MOBILE DEVICE RECOMMENDATIONS

(75) Inventors: Tao Mei, Beijing (CN); Ying-Qing Xu, Beijing (CN); Xian-Sheng Hua, Beijing (CN); Shipeng Li, Beijing (CN)

(73) Assignee: Microsoft Corporation, Redmond, WA (US)

(21) Appl. No.: 12/784,728

(22) Filed: May 21, 2010

(51) Int. Cl. G06Q 99/00; G06F 17/30; G01S 19/42

(52) U.S. Cl. 705/347; 342/357.25; 707/706; 707/E17.108

(57) ABSTRACT

Users may browse web pages, interact with a plethora of applications, search for new content, and perform a wide variety of other tasks using a mobile device. Unfortunately, useful content may be difficult for a user to locate because of the large amount of content available (e.g. hundreds of thousands of applications within an application store). Accordingly, one or more systems and/or techniques for determining recommendations are disclosed herein. In particular, user input (e.g., text, numbers, etc.) and/or a user profile (e.g., contextual information relating to a user) may be used to determine a user intent. Recommendations may be determined based upon the user intent. For example, a user may input “I am hungry” using a mobile phone having a GPS location of Downtown and a noon timestamp. Using this information, an application allowing the user to make lunch reservations at local restaurants may be provided as a recommendation.

### BACKGROUND

Today, mobile devices are becoming increasingly connected, powerful, and versatile. Mobile devices are capable of performing many tasks that previously required a personal computer for operation. Some features of mobiles devices may comprise phone connectivity, operating systems, internet connectivity, web browsers, downloadable applications, GPS, etc. For example, a user may want to order pizza for pick-up. However, the user may not be aware of what local pizza shops are available and their respective phone numbers or websites. The user may manually connect to a search engine to search for local pizza shops. Unfortunately, current mobile devices may be unable to provide context aware recommendations for the user. For example, current mobile devices may not leverage information about the user (e.g., GPS location, calendar events, stored media files, etc.) and/or user input (e.g., a text or numerical input) to provide the user with a robust experience, such as directing the user to an online pizza ordering service.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for determining a recommendation based upon a user profile and/or user input on a mobile device are disclosed herein. A user may interact with a mobile device, such as a cell phone, PDA, smart phone, laptop, tablet PC, hand-held gaming device, and/or other mobile devices. User input, such as keypad input and/or voice input, on the mobile device may be received. User intent may be determined based upon the user input on the mobile device. In one example, a user profile may be determined and utilized in determining the user intent. The user profile may be derived from a GPS location, calendar data, file data, and/or other information relating to the user. In one example, the user may say “I am hungry” into a cell phone, which may be received as user input. The word “hungry” may be used to determine that the user may desire a recommendation relating to food. A user profile comprising a calendar entry “Today: lunch with friend”, a time stamp of 12:30 p.m. and a GPS location of Downtown may be determined. A recommendation comprising information relating to grocery stores and/or lunch type restaurants near the Downtown may be determined for the user. For example, the user may be presented with a third party application for ordering lunch.

It may be appreciated that a recommendation may be provided to the user without receiving user input. For example, a user profile comprising a time stamp of 6:30 p.m. and a calendar entry of “Today at 8:00 p.m.: take spouse to the Cinema” may be determined for a user of a mobile device. A recommendation comprising a list of tonight's movies at the Cinema and a means for reserving seats may be presented on the mobile phone.

A recommendation may comprise a variety of information in numerous forms. In one example, a recommendation may comprise access to an agent service, where the user intent corresponds directly to the agent service (e.g., a website of a particular pizza shop requested by the user, an application of the Cinema requested by the user, etc.). In another example, a recommendation may comprise access to one or more third party applications, where the uses intent corresponds to a variety of third party applications (e.g., an online restaurant reservation application, a vacation booking application, etc.). In another example, a recommendation may comprise a search engine query, where the user intent does not correspond directly to an agent service or third party applications. In such cases, the user may be provided with search results corresponding to the user intent. In another example, coupons, images, media, advertisements, and/or other content may be provided as a recommendation. A variety of different recommendations are contemplated as falling within the scope of the claimed subject matter. It may be appreciated that a recommendation may comprise a combination of content. For example, a recommendation may comprise a coupon, an agent service, and a list of third party applications.

It may be appreciated that a user may be provided with direct access to a service without determining the user's intent. That is, the user input comprising a numerical reference may be directly matched with a corresponding service by consulting a table of services and numerical reference to determine a match. In one example, a direct access component may be used to receive user input of a numerical reference. Without determining user intent, the direct access component may match the numerical reference with a target website, for example, by consulting an index table. The direct access component may provide the user with direct access to the target website.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow chart illustrating an exemplary method of determining a recommendation based upon user input on a mobile device.

FIG. 2 is a component block diagram illustrating an exemplary system for determining a recommendation based upon user input on a mobile device.

FIG. 3 is an illustration of an example of an intent component receiving user input as a string of text.

FIG. 4 is an illustration of an example of an intent component and/or a direct access component receiving user input as a string a numbers.

FIG. 5 is an illustration of an example of an intent component receiving user input as voice input.

FIG. 6 is an illustration of an example of presenting recommendations determined from a user profile of user data associated with a PDA.

FIG. 7 is an illustration of an example of determining a recommendation based upon user input and/or a user profile.

FIG. 8 is an illustration of an example of determining a recommendation based upon user input and/or a user profile.

FIG. 9 is an illustration of an example of determining a recommendation based upon user input and/or a user profile.

FIG. 10 is an illustration of an exemplary computer-readable medium wherein processor-executable instructions configured to embody one or more of the provisions set forth herein may be comprised.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many mobile devices have substantial software and hardware capabilities that enable a plethora of applications for such mobile devices. Users may watch movies, play games, share photos, map directions, develop documents, download applications, make dinner reservations, and/or perform a vast array of other tasks using a mobile device. Because a mobile device may provide more content than a user may be able to sort through, it may be advantageous to provide recommendations to users. In this way, a user may quickly and efficiently locate desired content and/or additional relevant content.

Current solutions may merely provide users with manual search functionality. In one example, a user may manually locate desired content, such as a web page, by performing keyword searches within a search engine. In another example, a user may manually browse an application store for an application configured to perform desired functionality, such as booking a vacation. Unfortunately, sifting through available content (e.g., websites, applications, phone lists, etc.) may prove a daunting task to a user. Thus, users may miss out on desired content because current mobile devices may not provide helpful guidance.

Accordingly, one or more systems and/or techniques for determining a recommendation based upon a user profile and/or user input on a mobile device are provided herein. In particular, context aware recommendations may be provided to users based upon user input and/or information about the user to provide the user with a robust experience. Recommendations allow the user to interactively select and consumer services, third party applications, context aware search engine queries, directed phone calls, targeted web pages, etc. Recommendations may be contextually relevant to the user based upon the user's demographics, historical dialing behaviors, events, interests, recently contacted agents, and/or other user profile information.

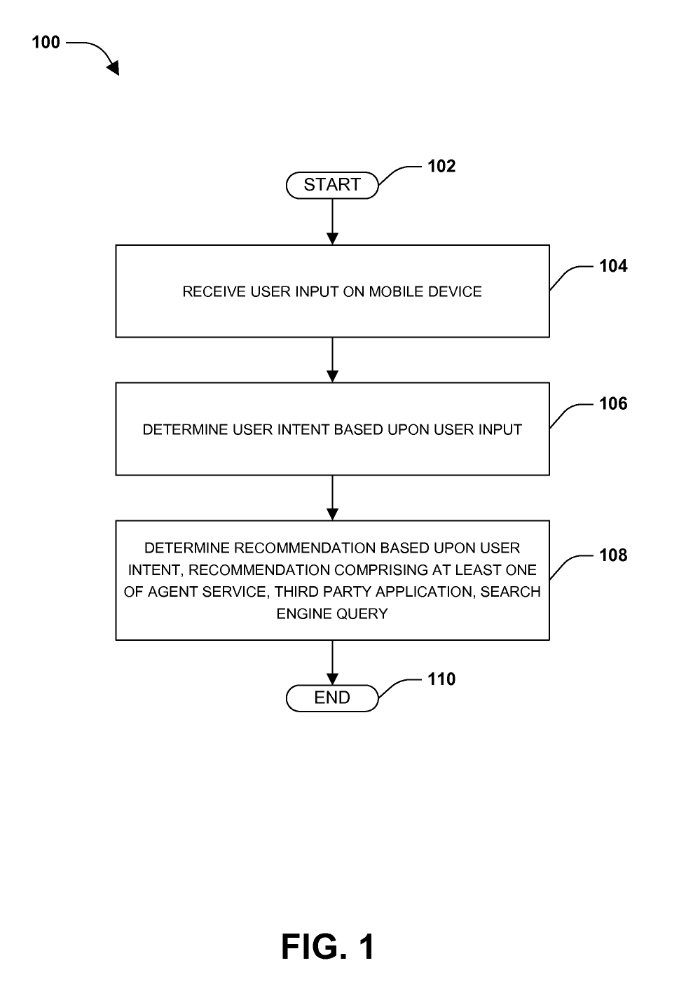

One embodiment of determining a recommendation based upon user input on a mobile device is illustrated by an exemplary method 100 in FIG. 1. At 102, the method begins. At 104, user input on a mobile device may be received. In one example, a user may input text, numbers, and/or symbols on a physical or virtual keypad. In another example, user input may comprise voice input. At 106, a user intent may be determined based upon the user input. In one example, the user input may be treated as a search query. In this way, features may be extracted from the search query. Using the extracted features, query classification techniques known in the art may be used to determine the context of the user input (e.g., “I am hungry” may be classified as food, which may be matched to recommendations regarding restaurants and/or grocery stores). In another example, user input may be parsed into words or phrases. The words or phrases may be used as keywords to search for related content that may be recommended to the user. A variety of different techniques for determining user intent based upon user input (e.g., query classification techniques, character matching, etc.) are contemplated as falling within the scope of the claimed subject matter.

In one example of determining the user intent, a user profile may be determined. That is, information associated with the user may be utilized in determining the context of the user input. In one example, the user profile may comprise a GPS location of the user based upon GPS data of the mobile device. In another example, the user profile may comprise calendar data of the user based upon a calendar of the mobile device (e.g., date, time, calendar events, etc.). In another example, the user profile may comprise file data of the user (e.g., information regarding: file history, contacts, images, music, data files, previous call data, previous search data, etc.). A variety of different user profile information is contemplated as falling within the scope of the claimed subject matter. The user profile and/or the user input may be used to determine the user intent. It may be appreciated that the determination of a user profile may be enabled or disabled based upon user preference.

At 108, a recommendation may be determined based upon the user intent. The recommendation may comprise at least one of an agent service, a third party application, a search engine query, and/or other content (e.g., advertisements, images, multimedia, text, coupons, phone numbers, hyperlinks to web pages, etc.). In one example, the user intent may match an agent service. For example, user intent derived from user input “Show me inventory at the Electronic Store” may be matched with a web page, phone number, and/or application hosted by the Electronic Store. The user may be provided with access to the matching agent service content. In another example, the user intent may match one or more third party applications. For example, user intent derived from user input “I need car insurance now” may be matched with a third party application allowing a user to estimate car insurance quotes, a third party application allowing the user to find car accident defense attorneys, and/or other relevant third party applications. The user may be provided with access to the matching third party applications.

In another example, the user intent may not match an agent service or third party applications. However, a search engine query corresponding to the user intent may be provided to the user, which may allow the user to quickly locate content relevant to the user's intent.

It may be appreciated that the user profile may be stored on the mobile device and/or within a remote database. The stored user profile may be update, for example, based upon user interaction with a recommendation.

The recommendation may be presented on the mobile device. In this way, the user may selectively consume content related to the recommendation. At 110, the method ends.

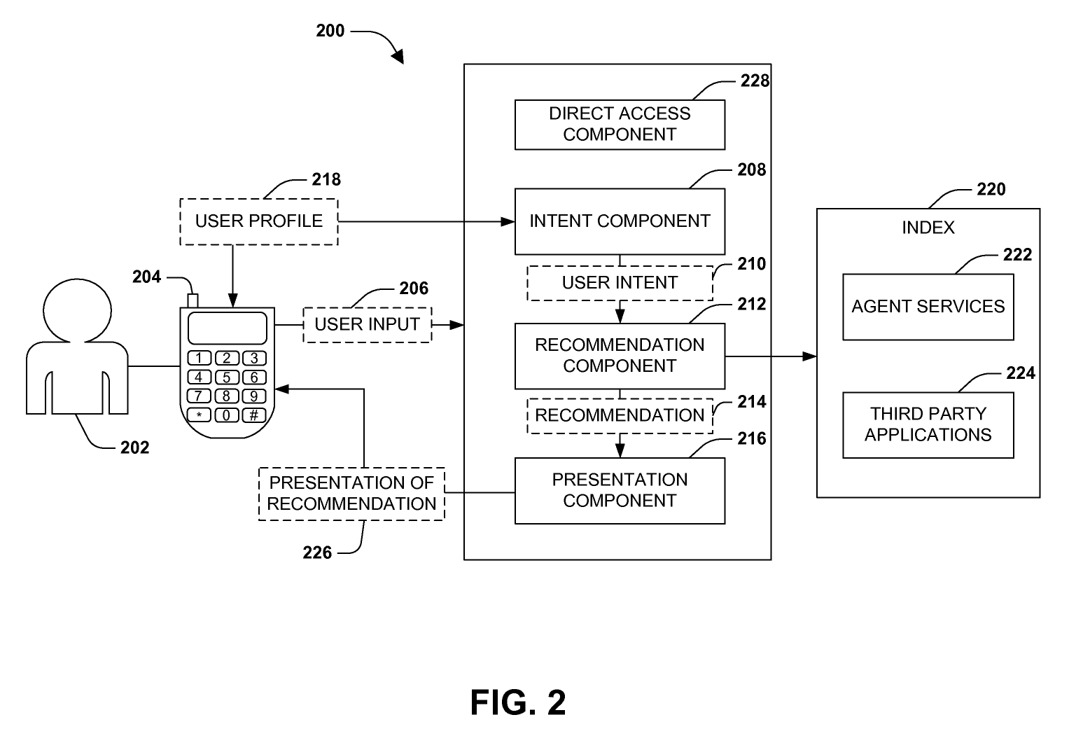

FIG. 2 illustrates an example of a system 200 configured for determining a recommendation 214 based upon user input 206 on a mobile device 204. The system 200 may comprise an intent component 208, a recommendation component 212, and/or a presentation component 216. The intent component 208 may be configured to receive user input 206 on the mobile device 204. The intent component 208 may determine a user intent 210 based upon the user input 206. The user intent 210 may be useful in determining desirable content sought by the user 202. In one example, the intent component 208 may be configured to determine a user profile 218 based upon GPS location of the user, calendar data, current time, file data, and/or other information associated with the user 202. The intent component 208 may determine the user intent 210 based upon the user input 206 and/or the user profile 218.

The recommendation component 212 may be configured to determine the recommendation 214 based upon the user intent 210. The recommendation 214 may comprise at least one of an agent service, a third party application, and/or a search engine query. The recommendation component 212 may consult an index 220. The index 220 may comprise an agent services data structure 222 and/or a third party applications data structure 224. It may be appreciated that an agent services data structure and a third party applications data structure may be located in the same or different index. It may be appreciated that the agent services data structure 222 may comprise actual agent service content or references to agent service content. It may be appreciated that the third party applications data structure 224 may comprise actual third party applications or references to third party applications. References may be used within the index 220 because the content may be large in disk size and/or may be located remote to the index 220.

In one example, the agent services data structure 222 may comprise content and/or references associated with agent services. For example, the agent services data structure 222 may comprise hyperlinks to web pages, text, references to multimedia content, references to applications, phone numbers, URLs, etc.). The recommendation component 212 may consult the index 220 to determine whether the user intent 210 matches an agent service within the agent services data structure 222. For example, user input 206 “I want to visit the Washington Monument” may be used to determine the user intent 210 relating to travel and the Washington Monument. The recommendation component 212 may match the user intent 210 with an agent service corresponding to a web page hosted by a historical group that provides tours of the Washington Monument. In this way, the recommendation 214 may be determined as a URL to the web page.

In another example, the third party applications data structure 224 may comprise references to applications and/or other content hosted by third party developers (e.g., a reference to a vacation booking application, a URL to a web page hosted by a third party hotel reservation company, etc.). The recommendation component 212 may consult the index 220 to determine whether the user intent 210 matches one or more third party applications within the third party applications data structure 224. For example, user input 206 “I want to visit the Washington Monument” may be used to determine the user intent 210 relating to travel and the Washington Monument. The recommendation component 212 may match the user intent 210 with a third party vacation booking application and a third party historical web page dedicated to the Washington D.C. In this way, the recommendation 214 may be determined as a list of links to the third party vacation booking application and the third party historical web page.

It may be appreciated that the user intent or a portion thereof may be used as a keyword search against the index 220 to determine matching agent services and/or third party applications indexed by search criteria, such as identifiers. For example, a third party online hotel reservation application may be indexed based upon identifiers “hotel”, “vacation”, “travel”, “reservations”, “weekend”, and/or other contextual identifiers.

In another example, the recommendation component 212 may determine that the user intent 210 does not match an agent service or a third party application. The recommendation component 212 may determine the recommendation 214 as a search engine query corresponding to the user intent 210.

It may be appreciated that the recommendation 214 may comprise one or more agent services, one or more third party applications, and/or other content. For example, the recommendation 214 may comprise a list of relevant agent services and third party applications from which the user may selectively invoke. It may be appreciated that the recommendation component 212 may provide other content, such as advertisements, query suggestions, multimedia content, and/or other content, within the recommendation 214.

The presentation component 216 may be configured to present the recommendation 214 on the mobile device 204 (e.g., presentation of recommendation 226). In this way, the user 202 may selectively consume desired content relevant to the user's intent as determined from the user profile 218 and/or the user input 206. It may be appreciated that the system 200 or a portion thereof may be comprised within the mobile device 204 or located remote to the mobile device 204.

In another example, the system 200 may comprise a direct access component 228. The direct access component 228 may be configured to receive a numerical reference, such as a string of numbers, as the user input 206. The direct access component 228 may be configured to provide direct access to a target website, phone number, and/or other content matching the numerical reference. In this way, the user 202 may provide a numerical reference to quickly access corresponding targeted content.

In another example of system 200, the intent component 208 may be configured to determining the user profile 218 without receiving user input. In this way, the user profile 218 may be used by the recommendation component 212 to determine the recommendation 214 without regard to user input and/or user intent derived from user input. The presentation component 216 may be configured to present the recommendation 214 on the mobile device 204 associated with the user 202. That is, recommendations may be determined and presented on the mobile device 204 based upon the user profile 218 without user input. For example, a mobile device may comprise a time stamp of 12:30 p.m. and a GPS location of Downtown. The user profile 218 may be determined based upon the time stamp and GPS location. The recommendation 214 may be determined as a list of lunch type restaurants near Downtown. In this way, recommendations may be automatically provided on the mobile device 204 without the user's request.

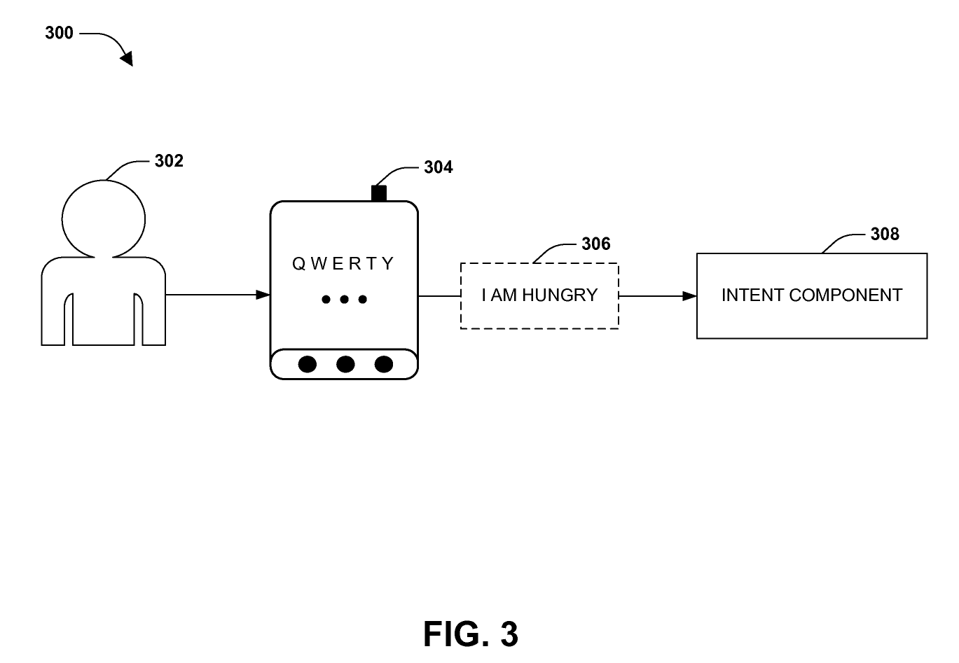

FIG. 3 illustrates an example 300 of an intent component 308 receiving user input 306 as a string of text. A user 302 may interact with a smart phone 304. For example, the user 302 may use a software keyboard to enter the user input 306 “I am hungry”. The intent component 308 may receive the user input 306 “I am hungry”. The intent component 308 may determine a user intent based upon the user input 306 “I am hungry”. For example, the user intent may be determined as one or more of “hungry”, “grocery store”, “shopping”, “restaurant”, “medical help”, and/or other intent designators. It may be appreciated that a variety of user intent classification techniques, such as query classification, may be used to determine the user intent from the user input 306 “I am hungry”. It may be appreciated that the intent component 308 may utilize a user profile when determining the user intent.

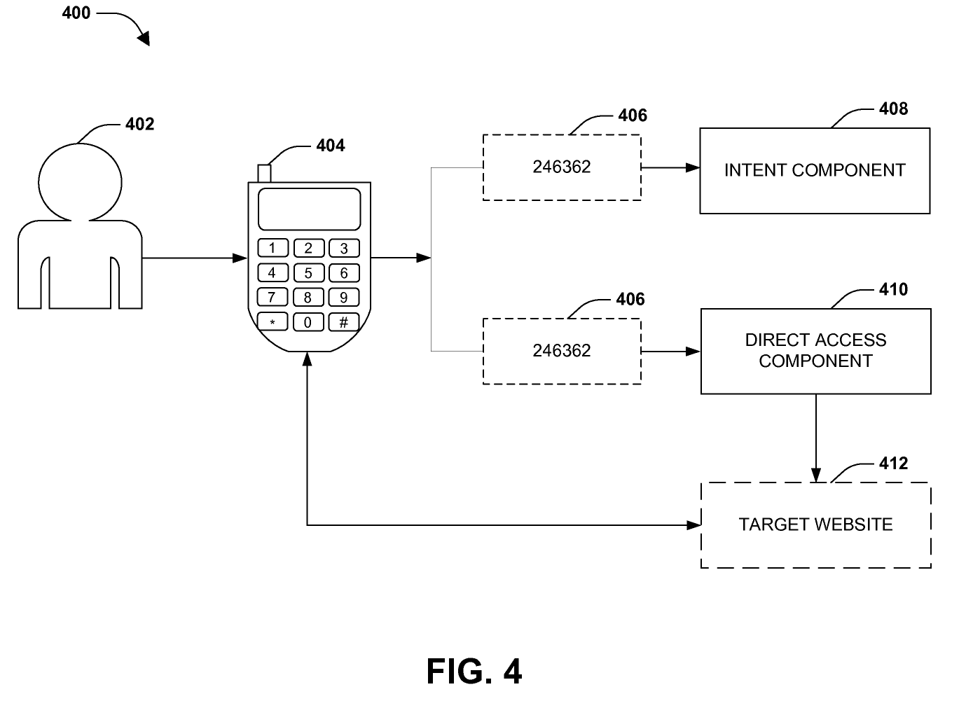

FIG. 4 illustrates an example 400 of an intent component 408 and/or a direct access component 410 receiving user input 406 as a string a numbers. A user 402 may interact with a cell phone 404. For example, the user 402 may use a keypad to enter the user input 406 “246362”. In one example, the intent component 408 may receive the user input 406 “246362”. The intent component 408 may determine a user intent based upon the user input 406 “246362”. For example, the user intent may be determined as a reference to agent services, third party applications, a phone number, and/or other content corresponding to the number “246362”. That is, the intent component 408 may consult an index to match the number “246362” with references corresponding to content. In this way, a recommendation may be determined based upon matched references. It may be appreciated that the intent component 408 may utilize a user profile when determining the user intent.

In another example, the direct access component 410 may receive the user input 406 “246362”. The direct access component 410 may determine the number “246362” corresponds directly to a target website 412. For example, a lookup table or index may be consulted to match the number “246362” with target content. In this way, the direct access component 410 may provide access to the target website 412 for the user 402.

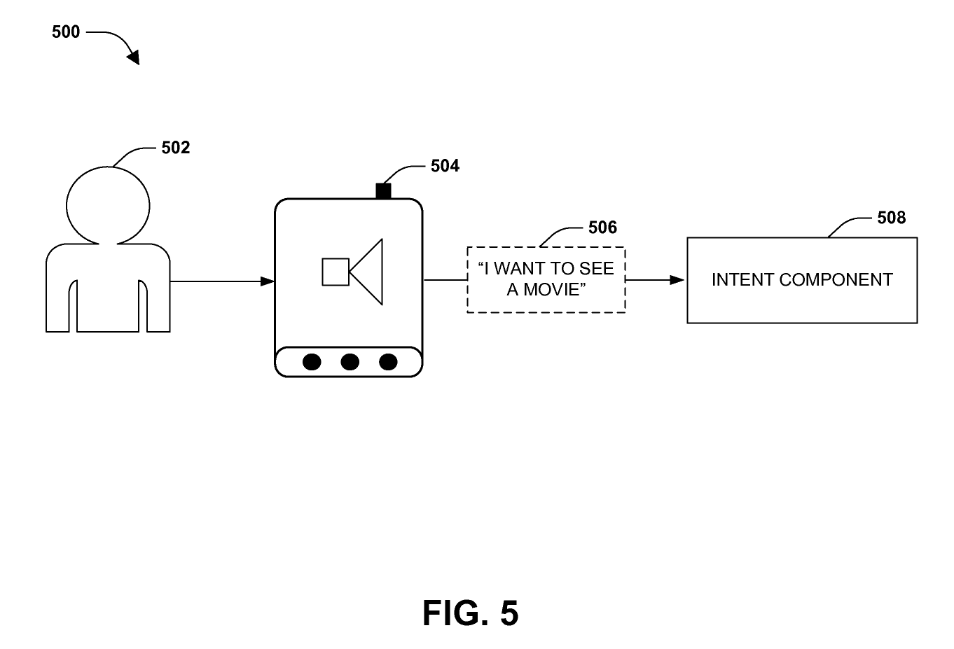

FIG. 5 illustrates an example 500 of an intent component 508 receiving user input 506 as voice input. A user 502 may interact with a tablet computing device 504. For example, the user may speak the user input 506 “I want to see a movie”. In one example, the intent component 508 may receive the user input 506 “I want to see a movie” as either voice data or text data converted from the voice input. The intent component 508 may determine a user intent based upon the user input 506 “I want to see a movie”. For example, the user intent may be determined as “date”, “movies”, “local cinemas”, “movie reviews”, “movie trailers”, “restaurants near local cinemas”, and/or other intent designators. It may be appreciated that a variety of user intent classification techniques, such as query classification and/or voice recognition techniques may be used to determine the user intent from the user input 506 “I want to see a movie”. It may be appreciated that the intent component 508 may utilize a user profile when determining the user intent.

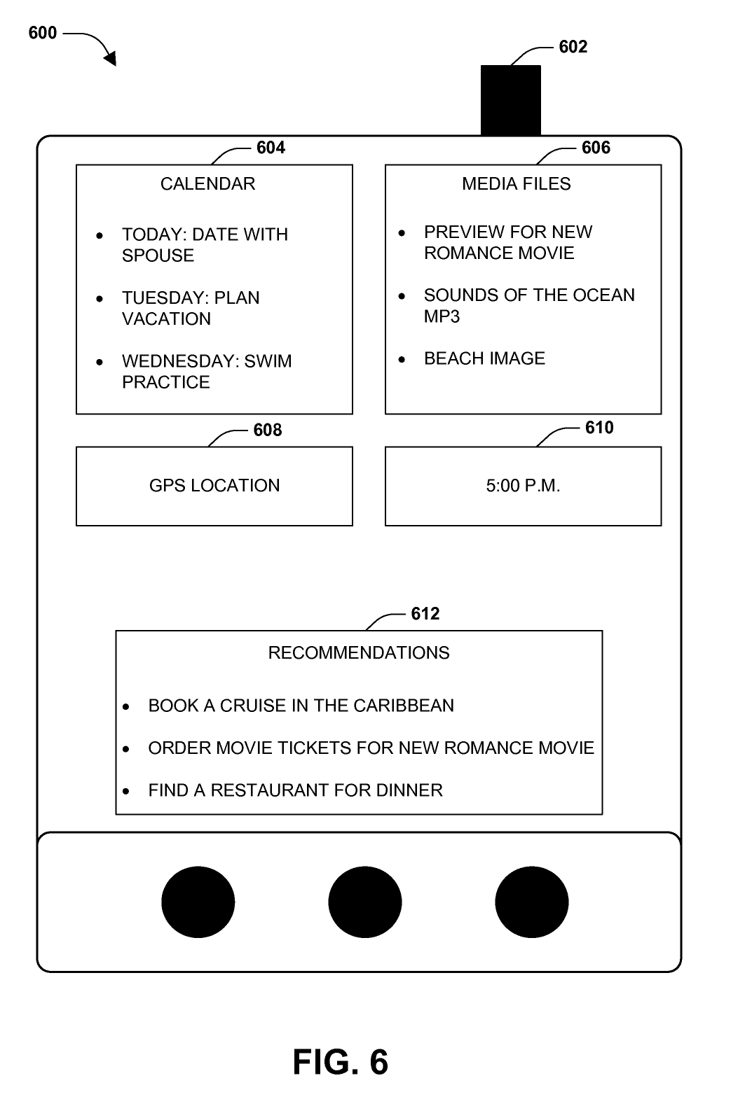

FIG. 6 illustrates an example 600 of presenting recommendations 612 determined from a user profile of user data associated with a PDA 602. A mobile device, such as the PDA 602, may comprise rich information about a user, such as the user's interests, activities, location, and/or other contextual information relating to the user. In one example, a calendar 604 may comprise event information (e.g., date with spouse, plan vacation, swim practice) and/or contextual information about the user (e.g., the user is interested in swimming and vacations). In another example, media files 606 may comprise content with which the user is interested (e.g., the user may want to see New Romance Movie, the user may enjoy the beach and ocean, the user enjoys relaxing music and images, etc.). Other information, such as a time stamp 610 and/or GPS location 608, may be extracted as information relating to the user. In this way, the calendar 604, media files 606, GPS location 608, the time stamp 610, and/or other information may be used in determining a user profile.

The user profile may be useful in determining a user intent from which the recommendations 612 may be determined. In one example, a third party application that allows users to book vacation cruises may be presented as a recommendation based upon a user intent of “ocean”, “plan vacation”, “swimming”, “beach”, etc. derived from the user profile (e.g., beach image, sounds of the ocean MP3, plan vacation, swim practice, etc.). In another example, a third party application that allows users to order movie tickets may be presented as a recommendation based upon a user intent of “date”, “New Romance Movie”, evening time, etc. derived from the user profile (e.g., preview for New Romance Movie, 5:00 p.m., date with spouse, etc.). In another example, a third party application that allows users to locate local restaurants may be presented as a recommendation based upon a user intent of “date”, “romance”, evening time, “movie”, Downtown location, etc. derived from the user profile (e.g., date with spouse, preview for New Romance Movie, 5:00 p.m., GPS location of Downtown, etc.). In this way, recommendations 612 relevant to the user may be determine.

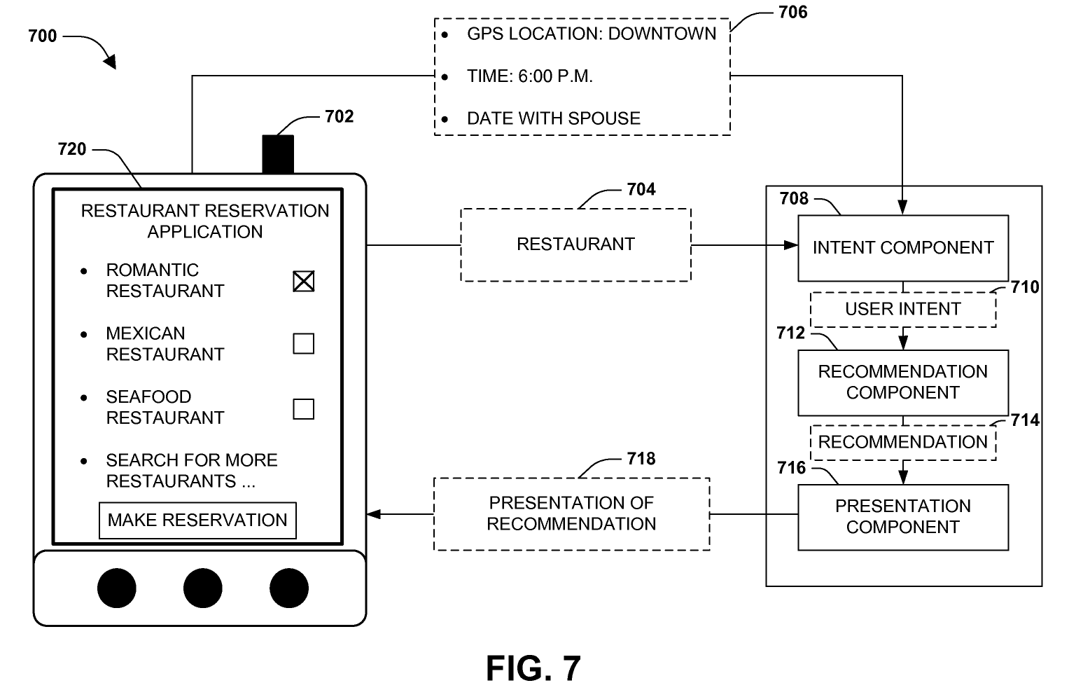

FIG. 7 illustrates an example 700 of determining a recommendation 714 based upon user input 704 and/or a user profile 706. A user may interact with a smart phone 702 by entering user input 704 “restaurant”. An intent component 708 may receive the user input 704 “restaurant”. In one example, the intent component 708 may determine the user profile 706 comprising a GPS location of Downtown, a time stamp of 6:00 p.m. and a date with spouse calendar event. The intent component 708 may determine a user intent 710 based upon the user input 704 “restaurant” and/or the user profile 706. For example, the user intent may comprise “romantic”, “dinner”, “restaurants”, “in downtown”, etc. A recommendation component 712 may be configured to determine the recommendation 714 based upon the user intent 710. For example, the recommendation 714 may comprise a restaurant reservation application 720 and/or other related content (e.g., a list of other third party applications related to the user intent 710).

A presentation component 716 may present the recommendation 714 on the smart phone 702 (e.g., presentation of recommendation 718). For example, access to the restaurant reservation application 720 may be provided. In this way, the user may interact with the restaurant reservation application 720 to reserve seats at the Romantic Restaurant. In one example, the recommendation 814 and/or reservation may be shared with other users, such as the spouse. For example, contact information for the spouse may be used to provide the recommendation and/or reservation to a computing device of the spouse (e.g., email device, cell phone, personal computer, etc.).

It may be appreciated that the user profile 706 may be stored on the smart phone 702 and/or in a remote location, such as a database within a cloud computing environment. In this way, the user profile 706 may be updated with contextual information relating to the user (e.g., the user prefers the Romantic Restaurant).

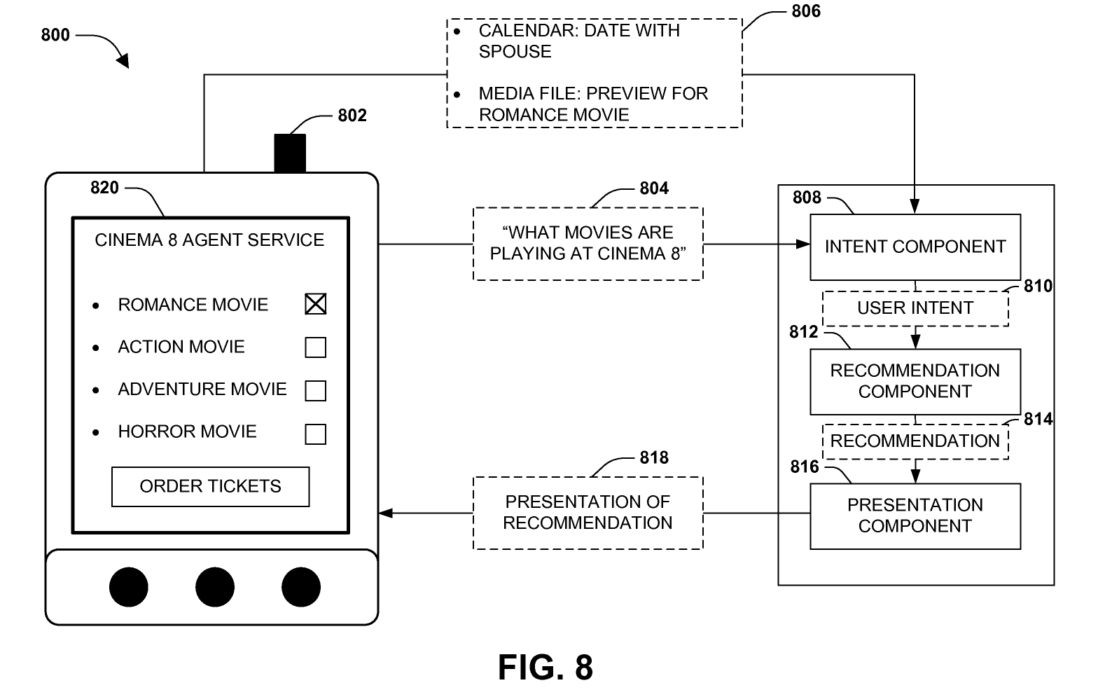

FIG. 8 illustrates an example 800 of determining a recommendation 814 based upon user input 804 and/or a user profile 806. A user may interact with a smart phone 802 by entering user input 804 “what movies are playing at Cinema 8”. An intent component 808 may receive the user input 804 “what movies are playing at Cinema 8”. In one example, the intent component 808 may determine the user profile 806 comprising a date with spouse calendar event and a preview for Romance Movie media file. The intent component 808 may determine a user intent 810 based upon the user input 804 “what movies are playing at Cinema 8” and/or the user profile 806. For example, the user intent may comprise “Cinema 8”, “movie theatres”, “romance”, etc. A recommendation component 812 may be configured to determine the recommendation 814 based upon the user intent 810. For example, the recommendation 814 may comprise Cinema 8 agent service 820 hosted by the owner of Cinema 8, which allows users to order movie tickets for Cinema 8.

A presentation component 816 may present the recommendation 814 on the smart phone 802 (e.g., presentation of recommendation 818). For example, access to the Cinema 8 agent service 820 may be provided. In this way, the user may interact with the Cinema agent service 820 to order tickets for the Romantic Movie. It may be appreciated that the recommendation 814 and/or the ticket order may be shared with other users. It may be appreciated that the user profile 806 may be updated based upon the user interaction with the Cinema 8 agent service 820.

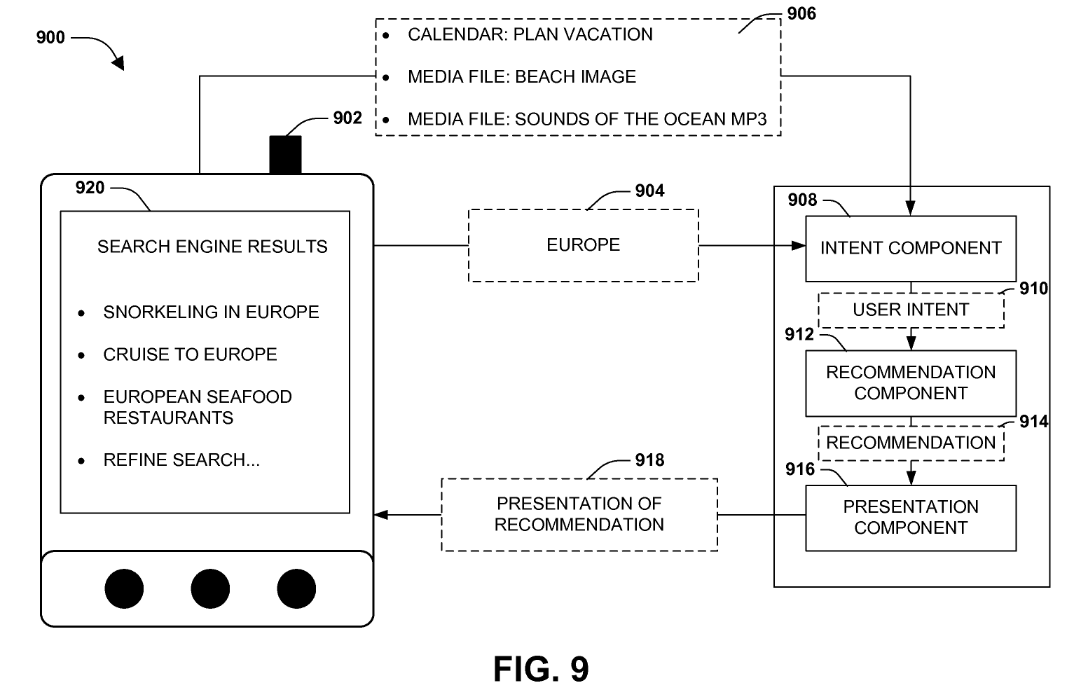

FIG. 9 illustrates an example 900 of determining a recommendation 914 based upon user input 904 and/or a user profile 906. A user may interaction with a mobile device 902 by entering user input 904 “Europe”. An intent component 908 may receive the user input 904 “Europe”. In one example, the intent component 908 may determine the user profile 906 comprising a plan vacation calendar event, a beach image media file, and a sounds of the ocean MP3 media file. The intent component 908 may determine a user intent 910 based upon the user input 904 “Europe” and/or the user profile 906. For example, the user intent may comprise “vacation”, “Europe”, “beach”, etc. A recommendation component 912 may be configured to determine the recommendation 914 based upon the user intent 910. For example, the recommendation 914 may comprise search engine results 920 for “European vacation near the beach”.

A presentation component 916 may present the recommendation 914 on the mobile device 902 (e.g., presentation of recommendation 918). For example, the search engine results 920 for “European vacation near the beach” may be presented on the mobile device 902. In this way, the user may be presented with search results linking to content related to the user input 904 “Europe” and/or the user profile 906.

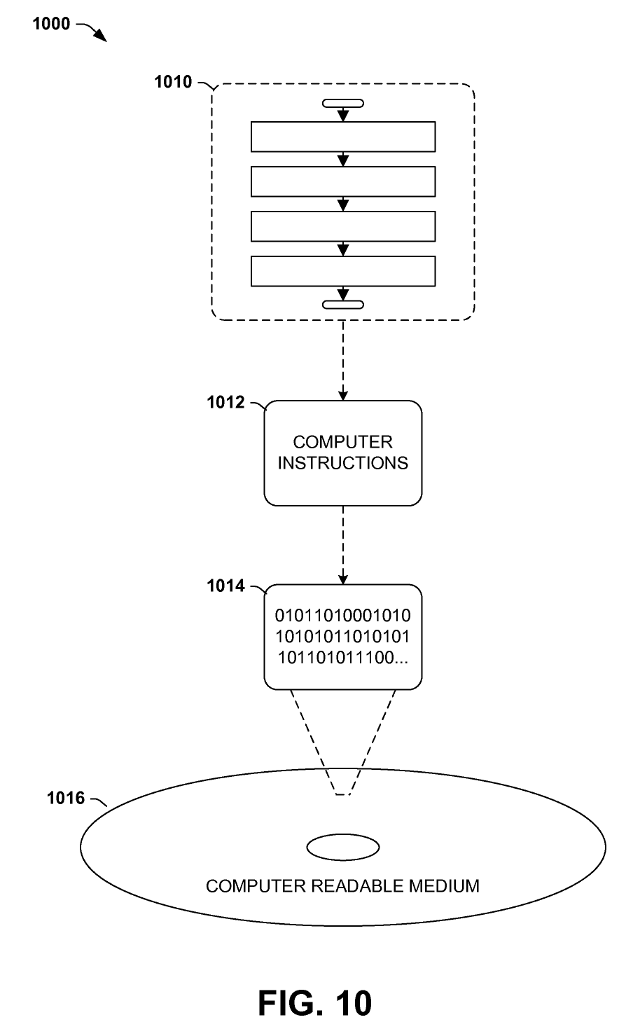

Still another embodiment involves a computer-readable medium comprising processor-executable instructions configured to implement one or more of the techniques presented herein. An exemplary computer-readable medium that may be devised in these ways is illustrated in FIG. 10, wherein the implementation 1000 comprises a computer-readable medium 1016 (e.g., a CD-R, DVD-R, or a platter of a hard disk drive), on which is encoded computer-readable data 1014. This computer-readable data 1014 in turn comprises a set of computer instructions 1012 configured to operate according to one or more of the principles set forth herein. In one such embodiment 1000, the processor-executable computer instructions 1012 may be configured to perform a method 1010, such as the exemplary method 100 of FIG. 1, for example. In another such embodiment, the processor-executable instructions 1012 may be configured to implement a system, such as the exemplary system 200 of FIG. 2, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

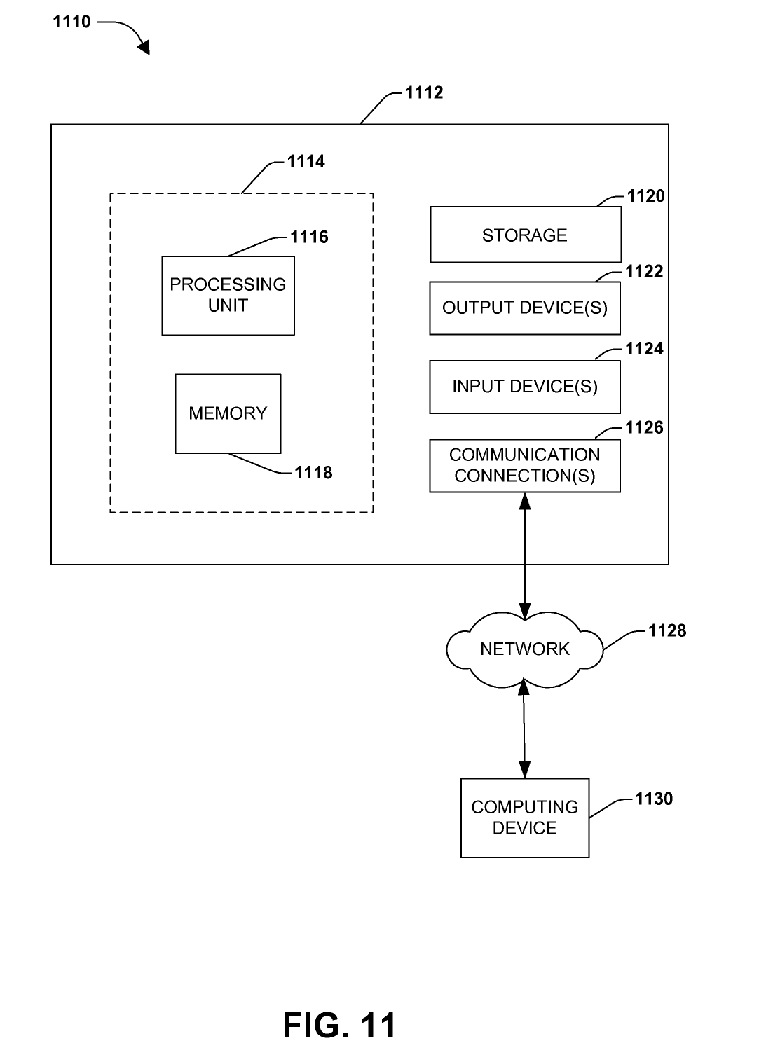

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 13114), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via a network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for determining a recommendation based upon user input on a mobile device, comprising:
receiving user input on a mobile device;
determining a user intent based upon the user input; and
determining a recommendation based upon the user intent, the recommendation comprising at least one of an agent service, a third party application, and a search engine query.

2. The method of claim 1, comprising:
presenting the recommendation on the mobile device.

3. The method of claim 1, the receiving user input comprising:
receiving user input comprising at least one of: keypad input and voice input.

4. The method of claim 1, the determining a user intent comprising:
determining a user profile; and
determining the user intent based upon the user input and the user profile.

5. The method of claim 4, the determining a user profile comprising:
determining a GPS location of the user based upon GPS data of the mobile device; and
utilizing the GPS location as the user profile.

6. The method of claim 4, the determining a user profile comprising:
determining calendar data of the user based upon a calendar of the mobile device; and
utilizing the calendar data as the user profile.

7. The method of claim 4, the determining a user profile comprising:
determining file data of the user based upon files associate with the mobile device, the file data comprising at least one of a file history, contacts, images, music, data files, previous call data, and previous search data; and
utilizing the file data as the user profile.

8. The method of claim 1, the determining a recommendation comprising:
matching the user intent with one or more third party applications; and
providing access to the one or more third party applications.

9. The method of claim 1, the determining a recommendation comprising:
matching the user intent with an agent service; and
providing access to the agent service.

10. The method of claim 1, the determining a recommendation comprising:
determining the user intent does not match at least one of an agent service and a third party application; and
providing a search engine query corresponding to the user intent.

11. The method of claim 4, comprising:
updating the user profile based upon user interaction with the recommendation.

12. A system for determining a recommendation based upon user input on a mobile device comprising:
an intent component configured to:
receive user input on a mobile device; and
determine a user intent based upon the user input; and
a recommendation component configured to:
determine a recommendation based upon the user intent, the recommendation comprising at least one of an agent service, a third party application, and a search engine query.

13. The system of claim 12, comprising:
a presentation component configured to:
present the recommendation on the mobile device.

14. The system of claim 12, the intent component configured to:
determine a user profile; and
determine the user intent based upon the user input and the user profile.

15. The system of claim 14, the user profile comprising at least one of:
a GPS location of the user;
calendar data of the user;
a current time associated with the user; and
file data of the user, the file data comprising at least one of a file history, contacts, images, music, data files, previous call data, an previous search data.

16. The system of claim 14, comprising:
a direct access component configured to:
receive a numerical reference as user input; and
provide direct access to a target website matching the numerical reference.

17. The system of claim 12, the recommendation component configured to:
match the user intent with one or more third party applications within an index of third party applications; and
provide access to the one or more third party applications.

18. The system of claim 12, the recommendation component configured to:
match the user intent with an agent service within an index of agent services; and
provide access to the agent service.

19. The system of claim 12, the recommendation component configured to:
determine the user intent does not match at least one of an agent service and a third party application; and
provide a search engine query corresponding to the user intent.

20. A system for presenting a recommendation on a mobile device comprising:
an intent component configured to:
determine a user profile from at least one of a GPS location of a user, a current time associate with the user, calendar data of the user, and file data of the user;
a recommendation component configured to:
determine a recommendation based upon the user profile, the recommendation comprising at least one of an agent service, a third party application, and a search engine query; and
a presentation component configured to:
present the recommendation on a mobile device associated with the user profile.
